(19) United States
(12) Patent Application Publication
(10) Pub. No.: US 2007/0058561 A1
(43) Pub. Date: Mar. 15, 2007

(54) Method and system for quality of service renegotiation

(75) Inventor: Kenneth E. Virgile, Lexington, MA (US)

Correspondence Address: WILMER CUTLER PICKERING HALE AND DORR LLP, 60 STATE STREET, BOSTON, MA, 02109, US

(73) Assignee: Starent Networks, Corp., Tewksbury, MA (US)

(21) Appl. No.: 11/487,725

(22) Filed: Jul. 17, 2006

Related U.S. Application Data
(60) Provisional application No. 60/700,123, filed on Jul. 18, 2005.

(51) Int. Cl. H04J 1/16

(52) U.S. Cl. 370/252; 370/468

(57) ABSTRACT

A method of renegotiating QoS levels of a communication link in one or more networks, the communication link having an initial QoS level prior to renegotiation, includes examining information flowing on the communication link between a first network endpoint and a second network endpoint. The method also includes determining, based on the information, a type of application being used by the first and second network endpoints for the communication link. The method further includes determining a QoS level that is suitable for the application, and negotiating with at least one of the one or more networks to procure resources associated with the network that will provide the suitable QoS level.

### CROSS REFERENCE TO RELATED APPLICATIONS

This application claims benefit of the following Patent Applications:
U.S. Provisional Patent Application Ser. No. 60/700,123, filed Jul. 18, 2005.

### BACKGROUND OF THE INVENTION

The present invention relates to wireless communication services, and more particularly, to techniques for changing quality of service in a communication network.

A network user typically has a quality of service (QoS) associated with his or her network connection. QoS is a term that describes the performance attributes of a connection that may include one or more communication links. Some exemplary performance attributes include, but are not limited to, data rate, error rate, rate of packet loss and packet latency. A user having a particular QoS associated with his or her network connection means that the network service provider guarantees a certain value for some or all of the these performance attributes. For example, a network service provider may simply guarantee “best effort,” meaning the network provider will do the best it can without committing to specific performance values. Or, the network provider may for example guarantee a certain minimum data rate or maximum error rate. Or, the network provider may provide its best effort to meet those rates, rather than guaranteeing the rates themselves.

A guaranteed minimum QoS is desirable for certain applications. For example, a guaranteed minimum QoS for a streaming video application is desirable because a certain minimum data rate is necessary to avoid buffering. Further, a certain minimum packet latency is necessary to provide real-time video display.

Other applications are not as dependent on a guaranteed QoS. For example, an e-mail application can tolerate a certain amount of packet latency and data rate variations, since e-mail is not a real-time application.

In general, a higher QoS level requires more network resources than a lower QoS level. Therefore it is desirable to provide only the minimum suitable QoS level for a particular connection, especially in networks that have limited resources.

FIG. 1 illustrates an exemplary radio access network (RAN; in this case, a cellular network) 102, connected to a packet data network (PDN, e.g., the Internet) 104. The RAN 102 includes a base station 106 in communication with a base station controller 108. The base station controller 108 communicates with a serving GPRS support node (SGSN) 112, which communicates with a gateway GPRS support node (GGSN) 114. The GGSN 114 is the gateway between the RAN 102 and the PDN 104.

A mobile device 110 (e.g., a cellular phone, a personal data assistant (PDA) or a laptop computer with a wireless adapter PCMCIA card) communicates with the base station 104 via a wireless communications link. Thus, in the system shown in FIG. 1, the mobile device 110 communicates with the PDN 104 through the RAN 102, the SGSN 112, and the GGSN 114.

The mobile device 110 is typically only one of many mobile devices communicating with the PDN 104 through the RAN 102. The QoS granted to each subscriber (i.e., mobile device user) does not depend on the particular type of application that the mobile device is using, but rather only on the Access Point Name (APN) used. As a result, a significant quantity of expensive radio resources are reserved for subscribers that don't require them. Because these subscribers won't use most of the bandwidth allocated, the network operator will not realize the expected revenues. At the same time, subscribers with real needs and a potential to generate substantial revenues can get rejected or experience poor service quality due to a lack of available resources.

### SUMMARY OF THE INVENTION

The embodiments described herein provide a system for and a method of renegotiating Quality of Service (QoS) of a communication link over a network from one network endpoint to another network endpoint. This traffic is transmitted over the communication link at some initial QoS assigned by the network. In these embodiments, a device examines traffic of the communication link to determine what type of application (also referred to herein as “type of service”) is using the communication link. Once the device determines the particular application using the communication link, the device requests a QoS from the network that is suited to the application. If the network cannot supply the requested QoS, the device may negotiate with the network to acquire the best available QoS.

The QoS that is suited to a particular application may be determined in a number of ways. Each application may have a particular QoS associated with it beforehand, and will be the same regardless of the user. Or, the QoS suited to a particular application may be a function of both the application and the user, so that each class of user will have a certain QoS for a given application.

In one aspect, the invention is a method of providing a QoS level in a network. The method includes examining communications flowing between a first network endpoint and a second network endpoint, and determining, based on the communications, an application being used by the first and second network endpoints for the communications. The method further includes determining a QoS level that is suitable for the application, and requesting resources associated with the network that will provide the suitable QoS level for the communication.

One embodiment further includes examining communications further includes analyzing packets flowing between the first and second network endpoints at a transport layer level. Another embodiment further includes examining communications further includes analyzing packets flowing between the first and second network endpoints at an application layer level.

In one embodiment, the suitable QoS level is a higher level of QoS as compared to a QoS level prior to requesting the resources. In another embodiment, the suitable QoS level is a lower level of QoS as compared to a QoS level prior to requesting the resources.

One embodiment further includes a dampening timer. Requesting the resources does not occur until the dampening timer expires.

In another embodiment, determining the suitable QoS level further includes examining a profile of at least one subscriber associated with the network endpoints, and linking the suitable QoS to the profile.

One embodiment further includes modifying billing records to reflect a change in QoS levels.

In another aspect, a method of renegotiating QoS levels of a communication link in one or more networks, where the communication link has an initial QoS level prior to renegotiation, includes examining information flowing on the communication link between a first network endpoint and a second network endpoint. The method further includes determining, based on the information, a type of application being used by the first and second network endpoints for the communication link. The method also includes determining a QoS level that is suitable for the application, and negotiating with at least one of the one or more networks to procure resources associated with the network that will provide the suitable QoS level.

In one embodiment, determining the suitable QoS level further includes examining a profile of at least one subscriber associated with the network endpoints, and linking the suitable QoS to the profile.

Another embodiment further includes modifying billing records to reflect a change in QoS levels.

In one embodiment, examining the information further includes analyzing packets flowing between the first and second network endpoints at a transport layer level. In another embodiment, examining the information further includes analyzing packets flowing between the first and second network endpoints at an application layer level.

In another aspect, a system for negotiating QoS levels of a communication link in one or more networks, where the communication link has an initial QoS level prior to the negotiation, includes a traffic analyzer for examining information flowing on the communication link between a first network endpoint and a second network endpoint, and determining, based on the information, a type of application being used by the first and second network endpoints for the communication link determining a QoS level that is suitable for the application. The system further includes a network negotiating component for negotiating with at least one of the one or more networks to procure resources associated with the network that will provide the suitable QoS level.

In one embodiment, the traffic analyzer and the network negotiating component are combined within a single unit. The single unit may be a GGSN.

In one embodiment, the traffic analyzer includes a transport layer packet analyzer. In another embodiment, the traffic analyzer includes an application layer packet analyzer. In another embodiment, the network negotiating component includes an interface to an SGSN. In yet another embodiment, the traffic analyzer determines the QoS level based on subscriber parameters provided by a RADIUS server.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 shows a block diagram view of a prior art radio access network connected to a packet data network.

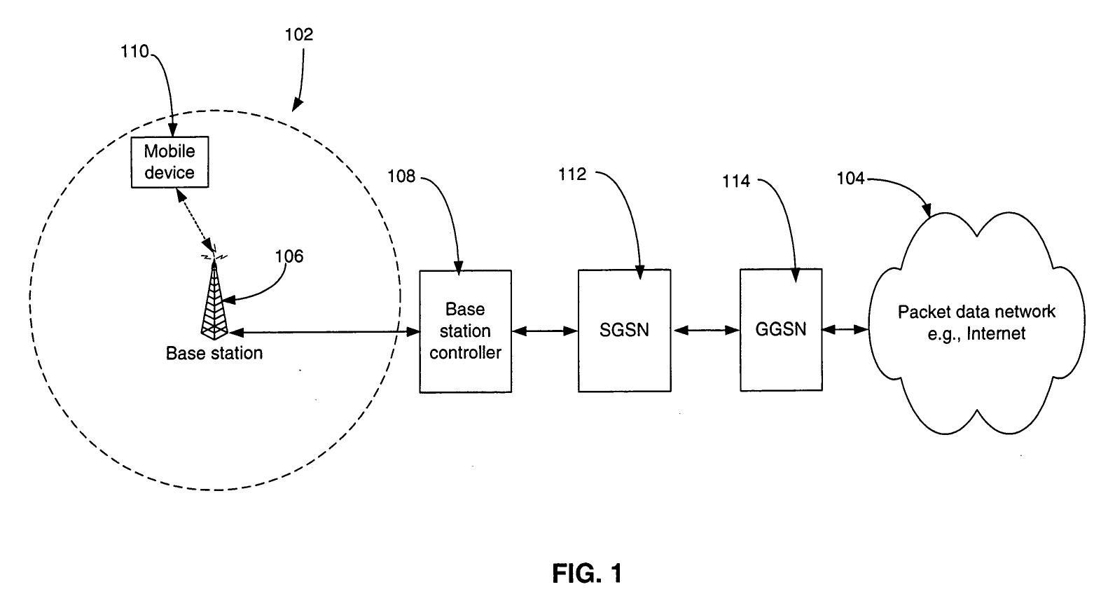

FIG. 2 shows a block diagram of one embodiment of a system for QoS renegotiation.

FIG. 3 shows another embodiment of the system shown in FIG. 2.

FIG. 4 shows an example of QoS renegotiation according to the described embodiments.

### DESCRIPTION OF THE PREFERRED EMBODIMENTS

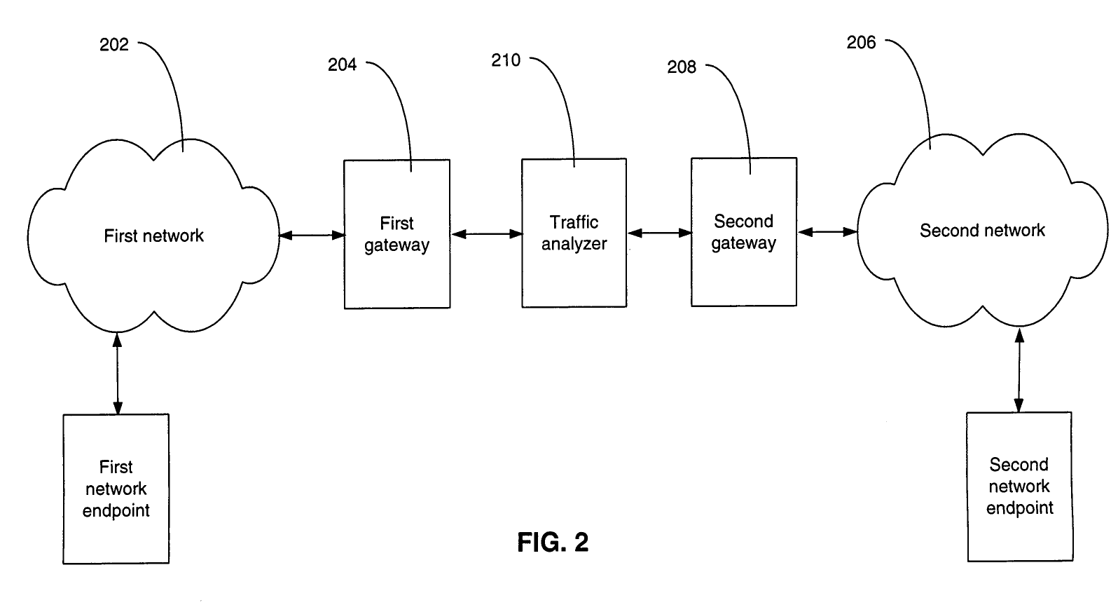

FIG. 2 shows a block diagram of one embodiment of a system for QoS renegotiation, which includes a first network 202, a first network gateway 204, a second network 206, a second network gateway 208, and a traffic analyzer 210. The system further includes a first network endpoint 212 and a second network endpoint 214. Although these components are shown in FIG. 2 as discrete, separate entities, in some embodiments these components may be integrated into various combinations. For example, in one embodiment the traffic analyzer 210 and the second network gateway 208 may be combined into a single unit.

In operation, the first network endpoint 212 and the second endpoint 214 establish a communication link through the first network 202, the first network gateway 204, the traffic analyzer 210, the second network gateway 204 and the second network 206. The techniques used to set up the communication link are known in the art and are beyond the scope of the present invention.

The first gateway 204 provides an interface to the first network 202, and is used to request and procure resources within the first network 202. Similarly, the second gateway provides an interface to the second network 206, and is used to request and procure resources of the second network 206.

Associated with the first network endpoint 212 and the second network endpoint 214 is an application for sending and receiving data. For example, the application may be a video streaming application, where the second network endpoint 214 sources streaming video content and the first network endpoint 212 receives the streaming video content. The information flow is typically bidirectional, to provide for status and handshaking information to flow between the two endpoints.

Upon establishing the communication link, the first network 202 and the second network 206 each provides an initial QoS for the communication link. The initial QoS for the first and second networks may or may not be the same.

The traffic analyzer 210 monitors the data flowing between the network endpoints 212, 214, and determines what application on the network endpoints is using the communication link. The various techniques for analyzing the data are described herein, although any technique known in the art for analyzing data and determining an associated application from the analysis may be used.

Once the traffic analyzer 210 determines the application, the traffic analyzer ascertains a suitable QoS for that particular application. A negotiating component (not shown) within the traffic analyzer 210 requests the suitable QoS from the first network gateway 204 and the second network gateway 208.

The first network gateway 204 determines whether the first network has sufficient network resources to grant the requested QoS. If sufficient resources exist, the first network gateway provides the requested QoS to the communication link between the first network endpoint 212 and the second network endpoint 214.

If the first network 202 does not have sufficient resources, or of the first network gateway determines for some other reason (e.g., insufficient account privilege) that the requested QoS should not be granted, the first network gateway 204 informs the traffic analyzer 210 that the requested QoS has not been granted.

If one or both of the gateways do not grant the requested QoS, the traffic analyzer 210 may propose an alternative QoS to the first network gateway 204 and/or the second gateway 208. Or, the traffic analyzer 210 may request a best available QoS from the gateways and take the highest level of QoS the associated networks can provide.

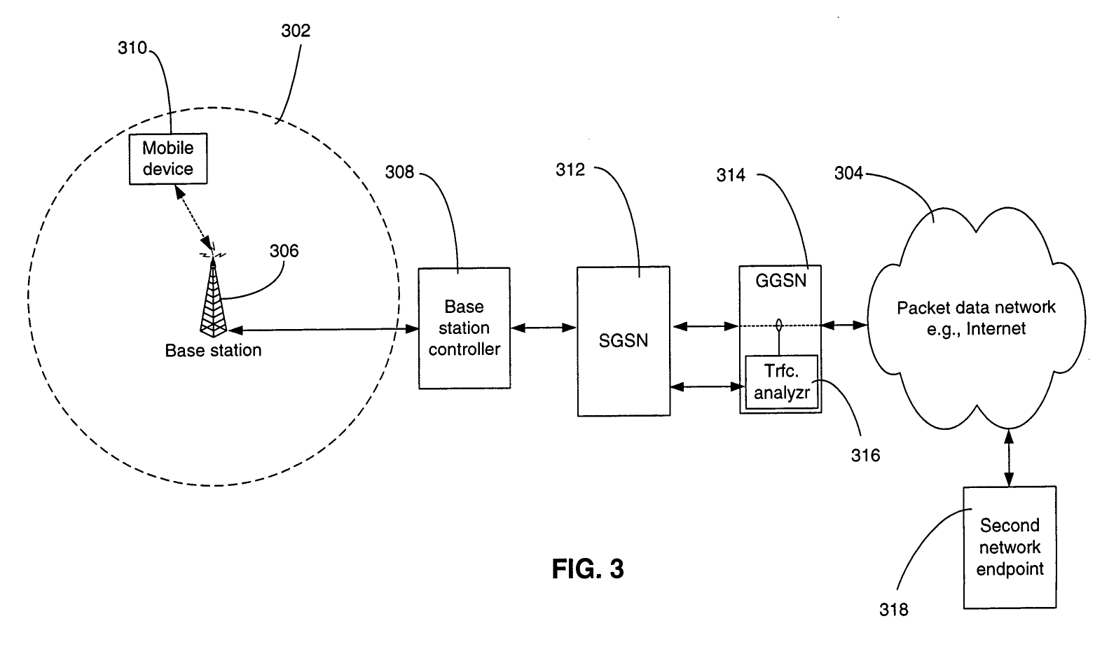

In one embodiment, shown in FIG. 3, the first network is a wireless network 302. In particular, the wireless network 302 is a cellular radio network based on 3GPP specifications known in the art. Although this described embodiment shows a particular cellular network, other wireless networks may also be used, including but not limited to, WLANs (e.g., WiFi), WiMAX (802.16), WiBro (wireless broadband), among others. Further, the networks described herein are not necessarily wireless, and may included wired networks (e.g., cable) or optical networks, for example.

In this embodiment, the gateway into the wireless network 302 is a serving GPRS support node (SGSN) 308. In this embodiment the second network 304 is the Internet, and the gateway into the Internet is a gateway GPRS support node (GGSN) 314.

The GGSN 314 hosts the traffic analyzer 316 in this embodiment. One example of such a GGSN with an integrated traffic analyzer is the Starent ST16 Intellegent Mobile Gateway. In operation, the GGSN 314 inspects packets of the data traffic passing through the networks from the mobile device 310 (i.e., the first network endpoint) to the second network endpoint 318, to detect the type of service (i.e., the application) being utilized. Once the GGSN 314 determines the type of service associated with the network endpoints, the GGSN 314 automatically renegotiates the QoS within the wireless network to the appropriate level, with a maximum QoS level corresponding to the level granted by the home location register (HLR).

The GGSN 314 performs QoS renegotiation by sending an update PDP context request to the SGSN 312. This solution is optimal since the appropriate QoS level is always granted to the subscriber without any requirement on the mobile device 310 or on the core network. The only prerequisite is QoS renegotiation support on the SGSN. In this model, over-reservation of radio resources is avoided, while maintaining the appropriate bandwidth for subscribers with real resource requirements. Further, by selecting the appropriate QoS level, the subscriber also avoids paying for unnecessary bandwidth.

In one embodiment, the GGSN 314 supports both L7 (OSI model layer 7) stateful service detection, and QoS renegotiation based on L4 (OSI model layer 4) packet inspection. Combining these functionalities results in dynamic QoS renegotiation. This embodiment of the GGSN 314 also generates CDRs (or real time charging information) that include the current QoS information and the service accessed. This enables intelligent application-based charging of services, taking into account the QoS granted through renegotiation. It also enables rebates to the subscriber when it was not possible to provide the QoS level required by an application.

In another embodiment, the traffic analyzer may interact with the second network gateway, rather than with the first network gateway, or in addition to the first network gateway.

In another embodiment, the traffic analyzer detects the application, but does not participate in the QoS renegotiation process. Instead, the traffic analyzer informs either the first or second network gateway of the application and/or desired QoS, and the gateway attempts the QoS renegotiation.

The main principles on which the described embodiments rely are explained below.

Initial QoS

When the session (i.e., the communication link) between the network endpoints is established, an initial level of QoS must be assigned to the subscriber 310. The GGSN 314 may either grant the requested QoS, or grant a lower QoS level (a minimum or intermediate level). The initial QoS remains in effect until the SGSN or GGSN requests a change. When the dynamic QoS renegotiation of the described embodiment is enabled, there are several conditions when the GGSN 314 would request a QoS change:
Idle

After a configurable time period of inactivity associated with the communication link, the GGSN 314 may request a QoS change to a lower specified value.
Services detected that do not require high QoS

After a configurable time period of a subscriber having terminated services that require high QoS, the GGSN 314 may lower the QoS to a value more appropriate to the services actually being used.
Services detected that require higher QoS

As soon as a subscriber begins using a service that requires a higher QoS, the GGSN 314 detects the use of this service/application and immediately requests a higher QoS from the network gateway.

Service Detection

There are two basic approaches that the traffic analyzer 316 can use to detect the use of a particular type of service (i.e., application). The first approach, referred to herein as “L4 packet inspection,” examines each packet transmitted via the communication link to determine the type of service that is being used.

The second approach, “application analysis,” uses application level (L7) information. In the described embodiment, application analysis is stateful; i.e., the application analysis keeps track of the application state.
L4 packet inspection

For L4 packet inspection, the GGSN 314 inspects every packet transmitted in the communications link between the first and second network endpoints to determine the type of application in use. For packet inspection to function properly, some embodiments institute minor restrictions. For example, real-time applications that use RTP must use standard UDP port numbers. Since the GGSN 314 analyzes packets before they passed through a device that modifies the port numbers, this restriction is easily accomplished.

Another potential problem are control protocols that run alongside RTP. These control protocols could cause a system to downgrade the QoS. In at least one embodiment, the GGSN 314 is configured to treat the control protocols as real-time applications, thereby mitigating this problem.

It should be noted that L4 service detection may be error prone any time services are provided in a non-standardized manner. A typical example is Windows Media Player 9. This player can be enabled for protocol rollover, which causes the server to use standard HTTP (i.e.—UDP port 80) to deliver streaming content. Some real-time applications may also dynamically allocate TCP/UDP port numbers. Performing L4 inspection to detect services can work, but requires subscribers to use a restricted set of standardized applications.

The advantages of L4 packet analysis is no or low impact on the system performance, and enables QoS adaptation with very limited impact on the GGSN 314 capacity.
Application layer analysis

For application layer analysis, the GGSN 314 performs L7 deep packet inspection to detect the type of application. This approach is more reliable since the analysis detects parameters at the OSI model application layer level (L7) instead of relying on data at the transport level (L4). For example, if HTTP is used for streaming, the GGSN 314 can be configured to interpret the access to a set of URLs as access to a streaming application. This avoids issues experienced by using L4 packet inspection.

Application analysis can also be used to determine the type of service for a bearer with unknown/non-standard TCP/UDP port numbers. For example, that would allow the GGSN 314 to detect dynamic port allocation by a control protocol before establishing the bearers for the application itself.

Another key aspect of application analysis is the ability to detect the end of a service. This is only possible with L7 stateful application analysis. For example, suppose a subscriber initiates a Push To Talk (PTT) service. This would be detected by L7 stateful application analysis of the control packets. The GGSN 314 would subsequently negotiate an appropriate QoS as soon as the control packets are seen, before the PTT data packets commence. The only reliable method to determine when the PTT data stream has been terminated is to monitor the control packets to keep track of the PTT application state. Thus, L7 stateful application analysis allows the GGSN 314 to detect the nature of each transaction on the communication link in real time, as well as each application's termination and status.

Once the GGSN 314 has detected and identified a particular type of service or application, the ST16 decides whether to renegotiate the QoS.

QoS Renegotiation

Once the GGSN 314 detects a service that requires QoS renegotiation, the GGSN 314 coordinates with the network gateways (or other network components associated with resource allocation) to renegotiate QoS levels.

Different types (i.e., levels) of QoS for different applications are well understood (e.g.,—web browsing should use the Interactive Traffic class), but different handsets might be programmed differently. If a handset is told of a new QoS, the handset's software might decide that the new QoS is insufficient and could terminate the session.

Another potential issue can arise when a subscriber performs multiple accesses. For example, consider a subscriber that initiates a connection, surfs the web, plays a song, does a little more web browsing and plays another song. If the GGSN 314 were to downgrade the QoS immediately after the first song completed, then it is possible that the resources would not be available to provide the QoS necessary for the second song.

Yet another issue arises if the subscriber performs more than one application at a time, such as viewing a video while downloading email. The GGSN would see the email packets and might attempt to lower the QoS.

To avoid this, the GGSN 314 in at least one embodiment provides a configurable “dampening timer.” When the connection begins, the GGSN 314 does not downgrade the QoS until the dampening timer expires. The dampening timer is restarted whenever a high-QoS application is used.

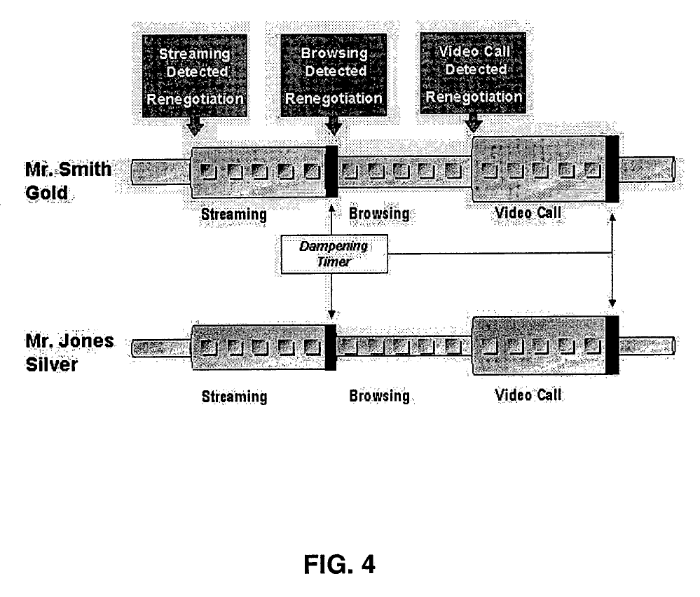

Consider this example of QoS renegotiation: Mr. Smith and Mr. Jones have gold and silver profiles respectively. Both profiles are the same, except the gold profile subscribers get double the bandwidth for Interactive applications, such as web browsing. The gold profile is, generally speaking, more expensive than the silver profile. FIG. 4 illustrates the difference between the profiles.

When the end of an application is detected, the GGSN 314 renegotiates a lower QoS for the next application that occurs after the dampening timer expires, as shown in FIG. 4. If the next application requires a higher QoS, the QoS is renegotiated immediately, without waiting for the dampening timer to expire. When there's no traffic at all, the GGSN 314 uses a default QoS. Note that some SGSNs may support PDP context preservation as defined by the 3GPP standards for when there's no traffic; however, that would only lower the QoS when there's no traffic and the traffic class was Conversational or Streaming.

A QoS specification has many parameters, and there could be different methods to determine whether one QoS is higher or lower than another QoS. The GGSN 314 simply uses the following list as a strict priority list from highest to lowest:
Conversational
Streaming
Interactive 1 (i.e.,—traffic handling priority 1)
Interactive 2
Interactive 3
Background

The 3GPP standards define a similar priority order for the possible traffic classes, which is to be used when PDP contexts must be deleted during an inter-SGSN handoff. The order of that list is the same, except it has Interactive 1 as the highest priority since it's more important to keep that service than Conversational/Streaming if the SGSN cannot support all of the PDP contexts during an inter-SGSN handoff.

QoS Renegotiation with Tiered Profiles

There are many options for how the GGSN 314 supports tiered profiles for different subscribers, and the different tiers may also be used for QoS renegotiation. Refer again to FIG. 4 with respect to the following description.

Because Mr. Smith is provisioned with a gold profile, he is granted high bandwidth amounts. Mr. Jones is provisioned with a silver profile, and is granted smaller bandwidth amounts, relative to Mr. Smith. During QoS renegotiation, the ST16 uses the different tiers to raise or lower the QoS to the appropriate level, based on the service and the subscriber's profile. This allows the mobile operator to offer tiered service level agreements (SLAs). The mobile operator will receive the benefits from both tiered SLAs and QoS renegotiation.

For any of the QoS renegotiations described herein, the renegotiations may be used to automatically trigger an update to billing records. For example, if QoS levels increase due to a particular application being detected, the billing records associated with the subscriber using the application can be modified to reflect the use of resources providing the increased QoS. Such automatic updating would provide more accurate accounting for actual resources used, ensuring that subscribers are not overcharged or undercharged. The described embodiments thus provide opportunities to define the QoS level based on subscriber attributes through a query to a RADIUS server.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method of providing a QoS level in a network, comprising:
examining communications flowing between a first network endpoint and a second network endpoint;
determining, based on the communications, an application being used by the first and second network endpoints for the communications;
determining a QoS level that is suitable for the application; and, requesting resources associated with the network that will provide the suitable QoS level for the communication.

2. The method of claim 1, wherein examining communications further includes analyzing packets flowing between the first and second network endpoints at a transport layer level.

3. The method of claim 1, wherein examining communications further includes analyzing packets flowing between the first and second network endpoints at an application layer level.

4. The method of claim 1, wherein the suitable QoS level is a higher level of QoS as compared to a QoS level prior to requesting the resources.

5. The method of claim 1, wherein the suitable QoS level is a lower level of QoS as compared to a QoS level prior to requesting the resources.

6. The method of claim 5, further including a dampening timer, wherein requesting the resources does not occur until the dampening timer expires.

7. The method of claim 1, wherein determining the suitable QoS level further includes examining a profile of at least one subscriber associated with the network endpoints, and linking the suitable QoS to the profile.

8. The method of claim 1, further including modifying billing records to reflect a change in QoS levels.

9. A method of renegotiating QoS levels of a communication link in one or more networks, the communication link having an initial QoS level prior to renegotiation, comprising:
examining information flowing on the communication link between a first network endpoint and a second network endpoint;
determining, based on the information, a type of application being used by the first and second network endpoints for the communication link;
determining a QoS level that is suitable for the application; and, negotiating with at least one of the one or more networks to procure resources associated with the network that will provide the suitable QoS level.

10. The method of claim 9, wherein determining the suitable QoS level further includes examining a profile of at least one subscriber associated with the network endpoints, and linking the suitable QoS to the profile.

11. The method of claim 9, further including modifying billing records to reflect a change in QoS levels.

12. The method of claim 9, wherein examining information further includes analyzing packets flowing between the first and second network endpoints at a transport layer level.

13. The method of claim 9, wherein examining information further includes analyzing packets flowing between the first and second network endpoints at an application layer level.

14. A system for negotiating QoS levels of a communication link in one or more networks, the communication link having an initial QoS level prior to the negotiation, comprising:
a traffic analyzer for examining information flowing on the communication link between a first network endpoint and a second network endpoint, and determining, based on the information, a type of application being used by the first and second network endpoints for the communication link determining a QoS level that is suitable for the application; and,
a network negotiating component for negotiating with at least one of the one or more networks to procure resources associated with the network that will provide the suitable QoS level.

15. The system of claim 14, wherein the traffic analyzer and the network negotiating component are combined within a single unit.

16. The system of claim 15, wherein the single unit is a GGSN.

17. The system of claim 14, wherein the traffic analyzer includes a transport layer packet analyzer.

18. The system of claim 14, wherein the traffic analyzer includes an application layer packet analyzer.

19. The system of claim 14, wherein the network negotiating component includes an interface to an SGSN.

20. The system of claim 14, wherein the traffic analyzer determines the QoS level based on subscriber parameters provided by a RADIUS server.
